(19) United States
(12) Patent Application Publication
(10) Pub. No.: US 2025/0309420 A1
(43) Pub. Date: Oct. 2, 2025

(54) BATTERY AND LASER WELDING SYSTEM

(71) Applicant: TRUMPF (China) Co., Ltd., Taicang (CN)

(72) Inventors: Yuan LIU, Taicang (CN); Peng ZHUO, Taicang (CN); Zekai HOU, Taicang (CN); Lianke TAN, Taicang (CN); Weiyu WANG, Taicang (CN); Franz LEHLEUTER, Shanghai (CN)

(21) Appl. No.: 19/235,746

(22) Filed: Jun. 12, 2025

Related U.S. Application Data
(63) Continuation of application No. PCT/CN2023/138460, filed on Dec. 13, 2023.

(30) Foreign Application Priority Data
Dec. 13, 2022 (CN) 202223345460.7

(51) Int. Cl. H01M 50/169; H01M 10/0525; H01M 50/103; H01M 50/119; H01M 50/15; H01M 50/159

(52) U.S. Cl. CPC H01M 50/169; H01M 50/103; H01M 50/119; H01M 50/15; H01M 50/159; H01M 10/0525

(57) ABSTRACT

A battery includes a housing with an opening, and a cover plate. The cover plate has an end face side facing the opening and an outer periphery connected to an opening periphery of the housing. A part of a peripheral section of the outer periphery has a first lateral welding zone. A part of a peripheral section of the opening periphery has a second lateral welding zone. At least one of the first lateral welding zone and the second lateral welding zone is formed with a weld seam shape control structure. The first lateral welding zone and the second lateral welding zone are welded together via a weld seam. The weld seam shape control structure is configured to control shaping of the weld seam so that a maximum lateral outer dimension of the weld seam does not exceed a maximum lateral outer dimension of a corresponding area before the welding.

### CROSS REFERENCE TO RELATED APPLICATIONS

This application is a continuation of International Application No. PCT/CN2023/138460 (WO 2024/125554 A1), filed on Dec. 13, 2023, and claims benefit to Chinese Patent Application No. CN 202223345460.7, filed on Dec. 13, 2022. The aforementioned applications are hereby incorporated by reference herein.

### FIELD

Embodiments of the present invention relate to a battery, in particular a lithium-ion battery and a corresponding laser welding system.

### BACKGROUND

With the advancement of technology and the increasingly stringent environmental protection requirements, more and more devices are beginning to use batteries as the power source. For example, electric vehicles have been developing rapidly in recent years, showing a trend of gradually replacing conventional vehicles.

Multiple batteries can form a module, and modules in turn can form a battery pack. As an electrical energy storage unit, a battery must have high energy density to store as much electrical energy as possible. Battery life is also one of the most critical factors, since damage to any one of the batteries may result in damage to the entire battery pack.

The manufacturing method of the battery not only affects the quality of the battery itself, but also determines the manufacturing efficiency. A battery pack usually contains numerous batteries, so it is particularly important to select an efficient manufacturing method. In the battery manufacturing process, an important step is to seal and weld the cover plate of the battery.

As many batteries need to be arranged to form a module, the accuracy of the outer dimensions, in particular the maximum lateral dimension of the battery is very important, and it is particularly important that the welding of the cover plate and the housing should not increase the maximum lateral dimension, since this will make it impossible to arrange the batteries in the expected manner. This is particularly important in the case of horizontal welding.

For the above reasons, corresponding improvements are required.

### SUMMARY

Embodiments of the present invention provide a battery. The battery includes a housing with an opening, and a cover plate for covering the opening. The cover plate has an end face side facing the opening and an outer periphery connected to an opening periphery of the housing enclosing the opening. At least part of a peripheral section of the outer periphery has a first lateral welding zone. At least part of a peripheral section of the opening periphery has a second lateral welding zone. At least one of the first lateral welding zone and the second lateral welding zone is formed with a weld seam shape control structure. By using a laser beam irradiated laterally from outside, the first lateral welding zone and the second lateral welding zone are welded together via a weld seam. The weld seam shape control structure is configured to control shaping of the weld seam during welding in such a manner so that a maximum lateral outer dimension of the weld seam does not exceed a maximum lateral outer dimension of a corresponding area corresponding to the weld seam before the welding.

### BRIEF DESCRIPTION OF THE DRAWINGS

Subject matter of the present disclosure will be described in even greater detail below based on the exemplary figures. All features described and/or illustrated herein can be used alone or combined in different combinations. The features and advantages of various embodiments will become apparent by reading the following detailed description with reference to the attached drawings, which illustrate the following:

FIG. 1 shows a partial perspective cross-sectional view of a housing and a cover plate of a battery before welding according to an exemplary embodiment;

FIG. 2 shows a perspective view of the housing and the cover plate of the battery shown in FIG. 1 after being partially welded, in which a weld seam on the left is formed by horizontal welding of an exemplary structural form according to some embodiments, and for comparison, a weld seam formed without said exemplary structural form is shown hypothetically on the right;

FIG. 3 shows a cross-sectional view of a housing and a cover plate of a battery before welding according to an exemplary embodiment, in which areas of focus according to embodiments of the present invention are schematically outlined with dotted circles;

FIG. 4 shows a cross-sectional view of a housing and a cover plate of a battery before welding according to another exemplary embodiment, presenting a weld seam shape control structure different from that of FIG. 3;

FIGS. 5, 6, 7, 8, and 9 respectively show cross-sectional views of a housing and a cover plate of a battery before welding according to other different exemplary embodiments, in which partial lateral retraction structures in some possible forms are provided; and

FIG. 10 schematically shows a welding manner according to an exemplary embodiment, taking the structural form of FIG. 3 as an example.

### DETAILED DESCRIPTION

Embodiments of the present invention provide an improved battery and a corresponding laser welding system.

According to a first aspect, provided is a battery which comprises: a housing with an opening; and a cover plate for covering the opening, wherein the cover plate has an end face side facing the opening and an outer periphery connected to an opening periphery of the housing enclosing the opening; wherein at least part of a peripheral section of the outer periphery has a first lateral welding zone, at least part of a peripheral section of the opening periphery has a second lateral welding zone, and at least one of the first lateral welding zone and the second lateral welding zone is formed with a weld seam shape control structure, and wherein by means of a laser irradiated laterally from the outside, the first lateral welding zone and the second lateral welding zone are welded together via a weld seam, and the weld seam shape control structure is configured to control shaping of the weld seam during welding in such a manner that a maximum lateral outer dimension of the weld seam does not exceed a maximum lateral outer dimension of a corresponding area corresponding to the weld seam before welding.

According to an embodiment, the weld seam shape control structure is formed on a lateral outer surface of the first lateral welding zone and/or the second lateral welding zone.

According to an embodiment, the outer periphery has an end face portion which is located on an end face of the opening periphery and thus welded to the end face, and the weld seam shape control structure is arranged adjacent to the end face portion and/or the end face.

According to an embodiment, the weld seam shape control structure comprises a lateral indentation structure which is laterally indented at least in part, at the first lateral welding zone and/or the second lateral welding zone, relative to an outermost point of the corresponding area corresponding to the weld seam before welding.

According to an embodiment, the lateral indentation structure comprises a first lateral indentation structure formed at the outer periphery and/or a second lateral indentation structure formed at the opening periphery.

According to an embodiment, the outer periphery has an exposed lateral portion, at which the first lateral indentation structure is formed.

According to an embodiment, the second lateral indentation structure is formed by laterally indenting an outer surface of a side wall of the housing at least in part relative to the outermost point of the corresponding area corresponding to the weld seam before welding.

According to an embodiment, the outer periphery has an embedded portion embedded in the opening, which embedded portion forms a step with the end face portion.

According to an embodiment, the first lateral indentation structure is formed by laterally indenting the entire exposed lateral portion and/or by a partial lateral retraction structure formed at the exposed lateral portion.

According to an embodiment, the second lateral indentation structure comprises a recessed area extending on the side wall of the housing in a direction away from the end face.

According to an embodiment, at least part of the embedded portion is welded to the side wall by the laser.

According to an embodiment, the partial lateral retraction structure comprises at least one of a step, a groove, and a bevel.

According to an embodiment, the recessed area extends from the end face in a direction away from the end face to the other end of the side wall opposite to the end face.

According to an embodiment, the step and/or groove is formed on at least one of two end edges of the exposed lateral portion.

According to an embodiment, the bevel is configured in a chamfered form.

According to an embodiment, the second lateral indentation structure is formed by indenting the entire outer surface of the side wall of the housing relative to the outermost point of the corresponding area corresponding to the weld seam before welding.

According to an embodiment, the weld seam shape control structure is formed surrounding the outer periphery and/or the opening periphery.

According to an embodiment, the weld seam shape control structure is formed through a gradual change from an arc welding starting point to an arc welding finishing point.

According to an embodiment, the weld seam shape control structure is formed only at an arc welding starting point.

According to an embodiment, the weld seam shape control structure is formed only at peripheral corners of the outer periphery and/or the opening periphery.

According to an embodiment, the battery is configured in a cuboid shape.

According to an embodiment, the housing and/or the cover plate is made of aluminum alloy.

According to an embodiment, the battery is a lithium-ion battery.

According to an embodiment, the housing and/or the cover plate is configured to be formed by stamping.

According to an embodiment, the cover plate is welded to the housing with the opening of the housing facing downwards.

According to an embodiment, the weld seam shape control structure is configured to be formed together with stamping forming of the housing and/or the cover plate.

According to a second aspect, provided is a laser welding system for the battery according to any of the above embodiments, which laser welding system comprises: a stationary welding head; and a controller, which is configured to cause the stationary welding head to perform welding starting from a position having the weld seam shape control structure to weld the cover plate to the housing.

According to some exemplary embodiments, at least one of the following advantages can be achieved or provided: the formation of weld seams can be controlled, particularly in terms of avoiding the uncontrolled oversize protrusion of the weld seams from affecting the compact arrangement of the adjacent batteries; in addition, it can be implemented easily, particularly by simple changes in the structure, shape, or even size of the housing and/or cover plate.

FIG. 1 shows a partial perspective cross-sectional view of a housing and a cover plate of a battery before welding according to an exemplary embodiment.

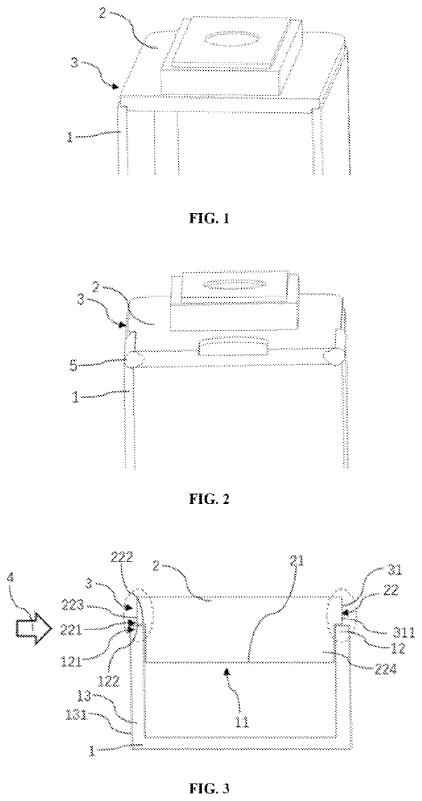

FIG. 2 shows a perspective view of the housing and the cover plate of the battery shown in FIG. 1 after being partially welded, in which a weld seam on the left is formed by horizontal welding of an exemplary structural form according to some embodiments, and for comparison, a weld seam formed without said exemplary structural form is shown hypothetically on the right.

FIG. 3 shows a cross-sectional view of a housing and a cover plate of a battery before welding according to an exemplary embodiment, in which areas of focus according to embodiments of the present invention are schematically outlined with dotted circles.

Referring to FIG. 3, according to one aspect of the present invention, a battery is provided, which comprises: a housing 1 with an opening 11 (the bottom of which is closed, as shown in FIG. 3); and a cover plate 2 for covering the opening 11, wherein the cover plate 2 has an end face side 21 facing the opening 11 and an outer periphery 22 connected to an opening periphery 12 of the housing 1 enclosing the opening 11; wherein at least part of a peripheral section of the outer periphery 22 has a first lateral welding zone 221, at least part of a peripheral section of the opening periphery 12 has a second lateral welding zone 121, and at least one of the first lateral welding zone 221 and the second lateral welding zone 121 is formed with a weld seam shape control structure 3, and wherein by means of a laser 4 irradiated laterally from the outside, the first lateral welding zone 221 and the second lateral welding zone 121 are welded together via a weld seam 5 (see FIG. 2), and the weld seam shape control structure 3 is configured to control shaping of the weld seam during welding in such a manner that a maximum lateral outer dimension of the weld seam 5 does not exceed a maximum lateral outer dimension of a corresponding area corresponding to the weld seam 5 before welding.

In other words, by using the weld seam shape control structure 3, it is ensured that the maximum lateral outer dimension of the finally formed weld seam 5 will not exceed an initial maximum lateral outer dimension before welding of the area where the weld seam is located, so that the pre-designed critical dimensions of the lateral sides will not be changed by the welding, avoiding any adverse impact on the subsequent battery assembling or arranging process. Thus, no extra processing steps, such as rolling, are required later to trim the weld seam 5.

For example, as shown in FIG. 2, the weld seam 5 on the left is formed with the presence of the weld seam shape control structure 3, in which case the lateral dimension on the lateral side does not expand outwards beyond the initial maximum lateral outer dimension of the same area (as can be seen through a comparison with the area located behind the weld seam 5 on the left in FIG. 2, which is not welded). On the contrary, as a result of the absence of the weld seam shape control structure 3, the dimension of the weld seam area in the corresponding position on the right side expands outwards in the lateral direction and goes beyond the initial maximum lateral outer dimension of this area. It should be pointed out that the weld seam on the right side of FIG. 2 is presented here hypothetically for comparison purposes.

Here, it should also be pointed out that the terms “end face” and “lateral side” are used in a relative sense to help clearly define the relative orientations between different structures or parts. Those skilled in the art are able to clearly understand this.

As shown in FIGS. 1-3, according to an exemplary embodiment, the weld seam shape control structure 3 is formed on a lateral outer surface of the first lateral welding zone 221 and/or the second lateral welding zone 121. In other words, the weld seam shape control structure 3 is located at an exposed position on the side facing the laser 4 for the convenience of shaping and processing. However, those of ordinary skill in the art can understand that the weld seam shape control structure 3 can not even be exposed to the outside, provided that the shaping of the weld seam 5 can be controlled.

According to an exemplary embodiment, as shown in FIG. 3, the outer periphery 22 has an end face portion 222 which is located on an end face 122 of the opening periphery 12 and thus welded to the end face 122, and the weld seam shape control structure 3 is arranged adjacent to the end face portion 222 and/or the end face 122. That is to say, the weld seam shape control structure 3 is arranged adjacent to an interface to be fused by laser welding so that it can provide a better effect.

By providing a relatively sunken structure/area that can accommodate molten materials during the welding process to avoid uncontrolled lateral accumulation on the lateral side, the shape of the weld seam can be controlled. For example, according to an exemplary embodiment, as shown in FIG. 3, the weld seam shape control structure 3 comprises a lateral indentation structure 31 which is laterally indented at least in part, at the first lateral welding zone 221 and/or the second lateral welding zone 121, relative to an outermost point of the corresponding area corresponding to the weld seam 5 before welding. This lateral indentation structure 31 may be formed through a subtractive manufacturing process.

It can be understood that by means of an uneven surface formed in the welding area through the subtractive manufacturing process, the laser absorptivity of the housing 1 and/or the cover plate 2 can also be increased, the consistency of welding can be improved, and welding spatter can be reduced, and it can also lower the welding heat input and reduces deformation of parts.

As shown in FIG. 3, the lateral indentation structure 31 comprises a first lateral indentation structure 311 formed at the outer periphery 22.

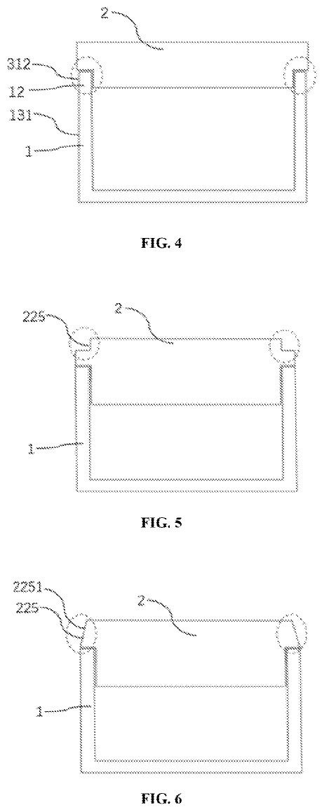

FIG. 4 shows a weld seam shape control structure 3 according to another exemplary embodiment.

Different from the exemplary embodiment shown in FIG. 3, the lateral indentation structure 31 shown in FIG. 4 comprises a second lateral indentation structure 312 formed at the opening periphery 12.

Those of ordinary skill in the art can understand that, in principle, the first lateral indentation structure 311 and the second lateral indentation structure 312 can exist at the same time.

As shown in FIG. 3, according to another exemplary embodiment, the outer periphery 22 has an exposed lateral portion 223, at which the first lateral indentation structure 311 is formed. In other words, the first lateral indentation structure 311 is completely exposed to the outside.

As shown in FIG. 4, according to another exemplary embodiment, the second lateral indentation structure 312 is formed by laterally indenting an outer surface 131 of a side wall 13 of the housing 1 at least in part relative to the outermost point of the corresponding area corresponding to the weld seam 5 before welding. In this case, the second lateral indentation structure 312 is achieved by controlling the outer surface 131 of the side wall 13 of the housing 1. This can be achieved by a corresponding control of the dimensions of the housing 1.

Preferably, the second lateral indentation structure 312 comprises a recessed area extending on the side wall 13 of the housing 1 in a direction away from the end face 122. In particular, the recessed area extends from the end face 122 in the direction away from the end face 122 to the other end of the side wall 13 opposite to the end face 122 (i.e., the lower end in the drawing). Such a recessed area may be a local recessed area relative to the outermost point of the outer surface 131 of the side wall 13 of the housing 1, or relative to the outermost point of the corresponding area corresponding to the weld seam 5 before welding, which means that the entire outer surface 131 of the corresponding side wall 13 now forms a recessed area relative to the outermost point of the corresponding area corresponding to the weld seam 5 before welding.

To this end, as shown in FIG. 4, according to another exemplary embodiment, the second lateral indentation structure 312 is formed by indenting the entire outer surface 131 of the side wall 13 of the housing 1 relative to the outermost point of the corresponding area corresponding to the weld seam 5 before welding.

As shown in FIG. 3, the outer periphery 22 has an embedded portion 224 embedded in the opening 11, which embedded portion 224 forms a step with the end face portion 222. The step is in an overlap joint with the opening periphery 12 from the inner side, so that the cover plate 2 can be positioned in a relatively stable manner to get prepared for the subsequent welding. Of course, this can also enhance the strength of the cover plate 2.

According to another exemplary embodiment, at least part of the embedded portion 224 is welded to the side wall 13 by the laser 4. Here, two interfaces intersecting, in particular perpendicular to each other are welded, which can greatly improve the welding strength. In this case, the laser 4 is preferably directed at an intersection of the two interfaces, namely, the corner of the step in FIG. 3.

According to another exemplary embodiment, as shown in FIG. 3, the first lateral indentation structure 311 is formed by laterally indenting the entire exposed lateral portion 223. In this case, the exposed lateral portion 223 as a whole is laterally indented. More preferably, as shown in FIG. 3, the entire exposed lateral portion 223 is indented by the same degree so that its side surface is flat.

Of course, the first lateral indentation structure 311 may also be formed by a partial lateral retraction structure 225 formed at the exposed lateral portion 223. FIG. 5 shows such an exemplary embodiment. As shown in FIG. 5, the partial lateral retraction structure 225 is formed in the form of a step at an outermost edge of the exposed lateral portion 223.

FIGS. 6, 7, 8 and 9 show cross-sectional views of a housing and a cover plate of a battery before welding according to other different exemplary embodiments, wherein some possible forms of the partial lateral retraction structure 225 are provided.

Referring particularly to FIGS. 6, 7, 8 and 9, the partial lateral retraction structure 225 may comprise at least one of at least one of a step, a groove, and a bevel 2251. Those skilled in the art can understand that these structural forms may appear simultaneously or individually.

As a more specific example, the step and/or groove may be formed on at least one of two end edges of the exposed lateral portion 223. For example, as shown in FIG. 8, the partial lateral retraction structure 225 is formed in the form of a step at an innermost edge of the exposed lateral portion 223. The bevel 2251 may be of any suitable form.

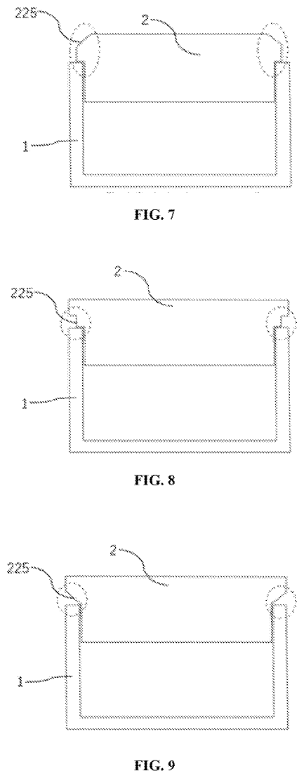

For example, as shown in FIGS. 6 and 7, the bevel 2251 may be configured in a chamfered form. The chamfer may be an angled chamfer as shown in the drawings, or a rounded chamfer. It should be pointed out that the bevel shown in FIG. 6 can also be considered as a chamfer, though two sides thereof are not symmetrical.

As shown in FIG. 6, in a thickness direction of the cover plate 2, the entire exposed lateral portion 223 may be configured as a bevel, or as shown in FIG. 7, only part of the exposed lateral portion is configured as a bevel.

According to an exemplary embodiment, the weld seam shape control structure 3 is formed surrounding the outer periphery 22 and/or the opening periphery 12. In this case, the cover plate 2 is connected all around to the housing 1 by laser welding.

It should be pointed out that as a result of the characteristics of welding per se, outward protrusion of the weld seam in the lateral direction is particularly easy to occur at a laser arc welding starting point but not in other positions, or it is less obvious in other positions. Therefore, according to another exemplary embodiment, the weld seam shape control structure 3 is formed only at an arc welding starting point. It can be understood here that when the weld seam shape control structure 3 is provided over the entire periphery, the welding can be started at any suitable starting point as needed.

Certainly, the weld seam shape control structure 3 may also be provided at an arc welding finishing point to allow the keyhole porosity at the arc welding finishing position to be reduced by increasing the laser power.

Those skilled in the art can understand that the weld seam shape control structure 3 may be formed through a gradual change in the peripheral direction. For example, it is possible to have a greater degree of material subtraction at the arc welding starting point, and the degree of material subtraction gradually decreases towards the arc welding finishing point, thereby obtaining a minimum degree of material subtraction at the arc welding finishing point. Various forms of gradual change are possible.

In the peripheral direction, the battery may have multiple corners, such as in the case of a cuboid battery as shown in the drawings, there are four corners. For the consideration of the welding process, it is advantageous to take the corner as an arc welding starting point, in which case the weld seam shape control structure 3 is formed only at peripheral corners of the outer periphery 22 and/or the opening periphery 12.

In principle, under certain circumstances, desired purposes can be achieved by forming the weld seam shape control structure 3 only on a lateral edge of one corner of the cover plate 2.

According to an exemplary embodiment, the housing 1 and/or the cover plate 2 is made of aluminum alloy. For another, the battery is a lithium-ion battery. In this case, a positive electrode, a negative electrode, a separator, electrolyte, etc. may be disposed in the housing 1, wherein a positive terminal and a negative terminal may be arranged on the cover plate 2.

According to an exemplary embodiment, the housing 1 and/or the cover plate 2 is configured to be formed by stamping. In particular, the aluminum-alloy housing 1 and/or cover plate 2 can be easily shaped through a stamping process.

Under such circumstances, it is advantageous that the weld seam shape control structure 3 is configured to be formed together with stamping forming of the housing 1 and/or the cover plate 2, so that it can be finished by a single forming process without the need for extra processing steps. Particularly, there is even no need to change the structural form of the stamping die for the structural forms shown in FIGS. 3 and 4, and adjustments of corresponding dimensions thereof will do.

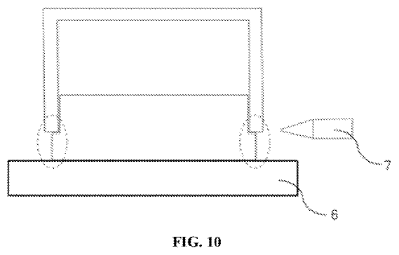

According to an exemplary embodiment, the cover plate 2 is welded to the housing 1 with the opening 11 of the housing 1 facing downwards. FIG. 10 schematically shows such a welding posture, taking the structural form of FIG. 3 as an example. As shown in FIG. 10, the cover plate 2 is supported on a worktable 6, and a laser welding head 7 irradiates from the side to perform welding. In this case, with the aid of recessed areas below, molten materials during the welding process will have a tendency of downward flowing, rather than accumulating sideways, under the action of gravity. Here, the laser welding head 7 is preferably a stationary welding head.

In practice, the welding manner can be adapted to the specific form of the weld seam shape control structure 3. Therefore, the above reversed welding manner is only exemplary.

During welding, it is also possible to employ a slow increase and/or slow reduction of the laser power during the welding process according to the specific form of the weld seam shape control structure 3 to further help to achieve the aforementioned purpose or to reduce or avoid weld craters generated in particular at the end of weld seams during cooling of the molten materials during the welding process.

In addition, the weld seam shape control structure 3 in some special forms can also help position and compress the housing and/or the cover plate during the assembly process, thereby reducing the accuracy requirements of welding fixture tools.

According to an exemplary embodiment, when the lateral indentation structure 31 is formed on the cover plate 2, a laterally indented dimension of the lateral indentation structure 31 may be 5% to 30% of a thickness of the cover plate 2. Taking a thickness greater than 1.0 mm of the cover plate 2 as an example, the laterally indented dimension is 0.05 mm to 0.5 mm, which is tiny and can be easily realized. The thickness of the housing 1 is preferably greater than 0.3 mm. Of course, the thickness of the housing 1 may also be considered when determining the laterally indented dimension.

According to another aspect of the present invention, provided is a laser welding system for the battery according to any of the above exemplary embodiments, which laser welding system comprises: a stationary welding head, and a controller which is configured to cause the stationary welding head to perform welding starting from a position having the weld seam shape control structure 3 to weld the cover plate 2 to the housing 1.

Although specific embodiments have been described in detail herein, they are presented for the purpose of explanation only and should not be construed as limitations on the scope.

While subject matter of the present disclosure has been illustrated and described in detail in the drawings and foregoing description, such illustration and description are to be considered illustrative or exemplary and not restrictive. Any statement made herein characterizing the invention is also to be considered illustrative or exemplary and not restrictive as the invention is defined by the claims. It will be understood that changes and modifications may be made, by those of ordinary skill in the art, within the scope of the following claims, which may include any combination of features from different embodiments described above.

The terms used in the claims should be construed to have the broadest reasonable interpretation consistent with the foregoing description. For example, the use of the article “a” or “the” in introducing an element should not be interpreted as being exclusive of a plurality of elements. Likewise, the recitation of “or” should be interpreted as being inclusive, such that the recitation of “A or B” is not exclusive of “A and B,” unless it is clear from the context or the foregoing description that only one of A and B is intended. Further, the recitation of “at least one of A, B and C” should be interpreted as one or more of a group of elements consisting of A, B and C, and should not be interpreted as requiring at least one of each of the listed elements A, B and C, regardless of whether A, B and C are related as categories or otherwise. Moreover, the recitation of “A, B and/or C” or “at least one of A, B or C” should be interpreted as including any singular entity from the listed elements, e.g., A, any subset from the listed elements, e.g., A and B, or the entire list of elements A, B and C.

1. A battery, comprising:
a housing with an opening; and
a cover plate for covering the opening, wherein the cover plate has an end face side facing the opening and an outer periphery connected to an opening periphery of the housing enclosing the opening;
wherein at least part of a peripheral section of the outer periphery has a first lateral welding zone, at least part of a peripheral section of the opening periphery has a second lateral welding zone, and at least one of the first lateral welding zone and the second lateral welding zone is formed with a weld seam shape control structure, and wherein by using a laser beam irradiated laterally from outside, the first lateral welding zone and the second lateral welding zone are welded together via a weld seam, and the weld seam shape control structure is configured to control shaping of the weld seam during welding in such a manner so that a maximum lateral outer dimension of the weld seam does not exceed a maximum lateral outer dimension of a corresponding area corresponding to the weld seam before the welding.

2. The battery according to claim 1, wherein
the weld seam shape control structure is formed on a lateral outer surface of the first lateral welding zone and/or the second lateral welding zone.

3. The battery according to claim 2, wherein
the outer periphery has an end face portion located on an end face of the opening periphery and being welded to the end face, and the weld seam shape control structure is arranged adjacent to the end face portion and/or the end face.

4. The battery according to claim 1, wherein
the weld seam shape control structure comprises a lateral indentation structure laterally indented at least in part, at the first lateral welding zone and/or the second lateral welding zone, relative to an outermost point of the corresponding area corresponding to the weld seam before the welding.

5. The battery according to claim 2, wherein
the weld seam shape control structure comprises a lateral indentation structure laterally indented at least in part, at the first lateral welding zone and/or the second lateral welding zone, relative to an outermost point of the corresponding area corresponding to the weld seam before the welding.

6. The battery according to claim 3, wherein
the weld seam shape control structure comprises a lateral indentation structure laterally indented at least in part, at the first lateral welding zone and/or the second lateral welding zone, relative to an outermost point of the corresponding area corresponding to the weld seam before welding.

7. The battery according to claim 4, wherein
the lateral indentation structure comprises a first lateral indentation structure formed at the outer periphery and/or a second lateral indentation structure formed at the opening periphery.

8. The battery according to claim 7, wherein
the outer periphery has an exposed lateral portion, at which the first lateral indentation structure is formed; and/or
the second lateral indentation structure is formed by laterally indenting an outer surface of a side wall of the housing at least in part relative to the outermost point of the corresponding area corresponding to the weld seam before the welding.

9. The battery according to claim 8, wherein
the outer periphery has an embedded portion embedded in the opening, wherein the embedded portion forms a step with the end face portion; and/or
the first lateral indentation structure is formed by laterally indenting an entire exposed lateral portion and/or by a partial lateral retraction structure formed at the exposed lateral portion; and/or
the second lateral indentation structure comprises a recessed area extending on the side wall of the housing in a direction away from the end face.

10. The battery according to claim 9, wherein
at least a part of the embedded portion is welded to the side wall by the laser beam; and/or
the partial lateral retraction structure comprises at least one of a step, a groove, and a bevel; and/or
the recessed area extends from the end face in a direction away from the end face to an other end of the side wall opposite to the end face.

11. The battery according to claim 10, wherein
the step and/or the groove is formed on at least one of two end edges of the exposed lateral portion; and/or
the bevel is configured in a chamfered form; and/or
the second lateral indentation structure is formed by indenting the entire outer surface of the side wall of the housing relative to the outermost point of the corresponding area corresponding to the weld seam before the welding.

12. The battery according to claim 1, wherein
the weld seam shape control structure is formed surrounding the outer periphery and/or the opening periphery; and/or
the weld seam shape control structure is formed through a gradual change from an arc welding starting point to an arc welding finishing point.

13. The battery according to claim 2, wherein
the weld seam shape control structure is formed surrounding the outer periphery and/or the opening periphery; and/or
the weld seam shape control structure is formed through a gradual change from an arc welding starting point to an arc welding finishing point.

14. The battery according to claim 1, wherein
the weld seam shape control structure is formed only at an arc welding starting point; and/or
the weld seam shape control structure is formed only at peripheral corners of the outer periphery and/or the opening periphery.

15. The battery according to claim 2, wherein
the weld seam shape control structure is formed only at an arc welding starting point; and/or
the weld seam shape control structure is formed only at peripheral corners of the outer periphery and/or the opening periphery.

16. The battery according to claim 1, wherein
the battery is configured in a cuboid shape; and/or
the housing and/or the cover plate is made of aluminum alloy; and/or
the battery is a lithium-ion battery.

17. The battery according to claim 2, wherein
the battery is configured in a cuboid shape; and/or
the housing and/or the cover plate is made of aluminum alloy; and/or
the battery is a lithium-ion battery.

18. The battery according to claim 1, wherein
the housing and/or the cover plate is configured to be formed by stamping; and/or
the cover plate is welded to the housing with the opening of the housing facing downwards.

19. The battery according to claim 18, wherein
the weld seam shape control structure is configured to be formed together with stamping forming of the housing and/or the cover plate.

20. A laser welding system for the battery according to claim 1, the laser welding system comprising:
a stationary welding head; and
a controller configured to cause the stationary welding head to perform welding starting from a position having the weld seam shape control structure to weld the cover plate to the housing.
